(19) United States
(12) Patent Application Publication
(10) Pub. No.: US 2004/0256348 A1
(43) Pub. Date: Dec. 23, 2004

(54) Flex panel lid or cap

(75) Inventors: James P. Stevens, Castleton, NY (US); Lawrence E. Renck, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc., Hartsville, SC

(21) Appl. No.: 10/602,030

(22) Filed: Jun. 23, 2003

(51) Int. Cl. B65D 39/12; B65D 39/00; B29C 45/14; B29C 45/16

(52) U.S. Cl. 215/262; 215/271; 215/305; 215/341; 215/364; 264/242; 264/255; 264/275; 264/279

(57) ABSTRACT

There is provided a lid with a center panel, a rim portion, and a hinge portion for sealing a container. The rim portion is designed to fit around an opening of a container and includes an inner wall for engaging a surface of the container opening. The hinge portion connects the rim portion to the center panel and includes flex points to allow axial movement of the center panel and corresponding radial movement of the rim portion to alternate the lid between an unsealing position and a sealing position. The sealing position provides an improved seal between the inner wall of the rim portion of the lid and the container. The lid may be formed by a two shot mold process in which the hinge portion consists of a more compliant material than the center panel and rim portion. The, lid may also include a flexible barrier membrane for enhanced sealing of the container.

### FIELD OF THE INVENTION

The present invention relates generally to lids or molded caps for containers.

More particularly, the invention relates to lids that seal container openings by providing an axially movable center panel of the lid that causes the container-engaging surface of the lid to move outward thus creating or improving the seal with the container surface.

### BACKGROUND OF THE INVENTION

Many foods or perishable goods are packaged in containers requiring repeated opening and closing. Once the container has been opened the first time by a consumer, the remainder of the product desired to be preserved generally must be stored in a sealed container. Therefore, resealable lids are preferably used to seal the product in the container to prevent exposure to contaminants, to prevent leakage of the contained product, and to maintain the freshness of the product. The originally sealed lid preferably also reduces transmission of moisture and oxygen, which expedite the spoilage of perishable goods.

Containers may include features to facilitate the sealing of the lid. U.S. Pat. No. 3,080,993 to Livingstone, discloses a container and cover wherein the rim of the container includes a groove engageable means. Once the cover is positioned onto the container such that the groove of the cover is positioned on the rim of the container, the knob is compressed to seal the container. The cover includes a thin flex line that allows the knob to move relative to the groove, and the cover includes a groove-engaging means that forms a tight engagement with the groove engageable means of the container when the knob is compressed. The covers are designed particularly for containers with groove engageable means.

Other lids, may create a seal, in a similar fashion, with a container that does not include special groove-engaging means. U.S. Pat. No. 3,244,308 to Esposito, discloses a molded cap with a skirt surrounding a transverse wall that is molded in a convex configuration and that includes grooves such that when the transverse wall is distorted to a concave configuration, the skirt exerts radial pressure on the container surface. The transverse wall and skirt of the cap are molded as a one piece integral structure. Furthermore, the cap does not include additional materials to enhance the barrier properties of the cap.

Lids of the above described type may be compressed or distorted many times during the expected life of the lid. Because the rigid structural portions and the moving portions of the lids consist of a single material, such iterations of compression or distortion may weaken or rupture the moving portions of the lid, thus rendering the lid inoperative or diminishing the sealing properties of the lid. Furthermore, the lids described above do not incorporate barrier-enhancing materials. Therefore, a need exists for a lid designed to withstand many iterations of sealing and unsealing without diminished performance and for a lid that provides enhanced barrier properties.

### SUMMARY OF THE INVENTION

The invention addresses the above needs and achieves other advantages by providing a flex panel lid that includes a center panel, a rim portion, and a hinge portion. The hinge portion connects an outer perimeter of the center panel to the rim portion and allows axial movement of the center panel relative to the rim portion. Axial movement of the center panel causes the rim portion to be moved in a radial direction. When the lid is positioned on a container opening, radial movement of the rim portion engages an inner wall of the groove of the rim portion against an inner surface of the container, thus creating a seal. The hinge portion comprises a material that is relatively more compliant than the material of the center panel and rim portion. The hinge portion in some embodiments of the invention includes two flex points.

One embodiment of the present invention includes a center panel and rim portion made of a thermoplastic material and a hinge portion made of an elastomer. A further embodiment includes a container-engaging surface made of pliable material that is more compliant than the other portions of the rim portion so as to promote sealing with the inner surface of the container. The lid may be structured so that axial movement of the center panel toward the container moves the rim portion radially outward, or the lid may be structured so that axial movement of the center panel away from the container moves the rim portion radially outward. The lid may also include a pull feature to facilitate axial movement of the center panel.

Another embodiment of the invention provides a molded cap with a center panel, a hinge portion; and a rim portion and includes a flexible barrier membrane integrated into the cap. In a further embodiment, the flexible barrier membrane may include a lower foil layer and an upper polymer layer for joinder with the polymer material of the molded cap. The cap may be molded onto the upper polymer layer of the flexible membrane such that the lower foil layer of the flexible membrane defines a container-facing surface of the cap. In other embodiments of the invention, the flexible membrane may extend radially to the groove of the rim portion and may be a metallized film such as metal foil.

A method of manufacturing a flex panel lid is provided. To manufacture one embodiment of the lid, a first mold material is injected into a mold to form a center panel and a rim portion encircling the center panel, then a second mold material different than the first mold material is injected into the mold to form a hinge portion connecting the outer perimeter of the center panel to the rim portion. Once the materials are hardened, the center panel is axially moveable relative to the rim portion. In one embodiment, the first mold material is less compliant than the second mold material. In a further embodiment, the first mold material is a thermoplastic material and the second mold material is an elastomer,

A method for manufacturing a molded cap is also provided. A flexible barrier membrane is positioned in the mold and a mold material is injected into a mold to form a center panel, a hinge portion, and a rim portion. After hardening of the mold material, the hinge portion allows the center panel to move axially relative to the rim portion. In one embodiment, the mold material is injected onto an upper polymer layer of the flexible membrane and the lower foil layer of the flexible membrane defines a container-facing surface of the cap. In a further embodiment the flexible barrier membrane extends radially to a container-engaging surface of the rim portion. In yet another embodiment, the flexible barrier membrane is a metallized film.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a lid, partially in section, in accordance with one embodiment of the invention;

FIG. 2 is a schematic, cross-sectional view of a lid, in accordance with a second embodiment of the invention, formed by a two shot mold process, showing the lid in the unsealing position;

FIG. 3 is a view similar to FIG. 2, showing the lid in the sealing position;

FIG. 4 is a view similar to FIG. 2, showing a lid, in accordance with a third embodiment of the invention, formed by a two shot mold process with a container-engaging surface in the groove of the rim portion formed of a different material from the rest of the rim portion, showing the lid in the unsealing position;

FIG. 5 is a view similar to FIG. 2, showing a lid, in accordance with a fourth embodiment of the invention, formed with a flexible barrier membrane, showing the lid in the unsealing position;

FIG. 6 shows the lid of FIG. 5 in the sealing position;

FIG. 7 is an enlarged, partial cross-sectional view of the lid shown in FIG. 5 showing the flexible barrier membrane molded to the hinge portion and the rim portion; and

FIG. 8 is a perspective view of a lid with a pull feature.

### DETAILED DESCRIPTION OF THE INVENTION

The present invention now will be described more fully hereinafter with reference to the accompanying drawings, in which some, but not all embodiments of the invention are shown. Indeed; the invention may be embodied in many different forms and should not be construed as limited to the embodiments set forth herein; rather, these embodiments are provided so that this disclosure will satisfy applicable legal requirements. Like numbers refer to like elements throughout.

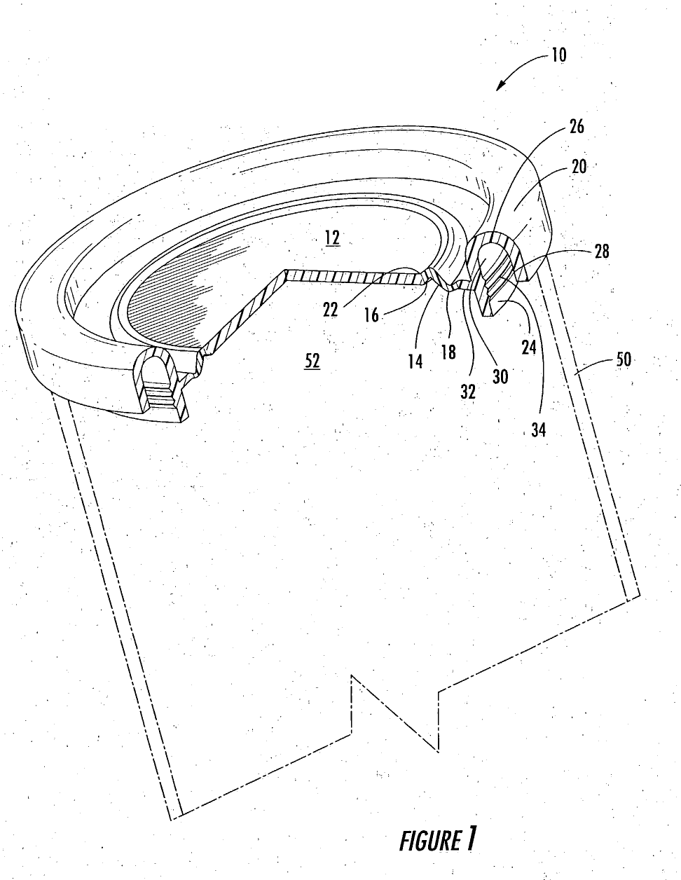

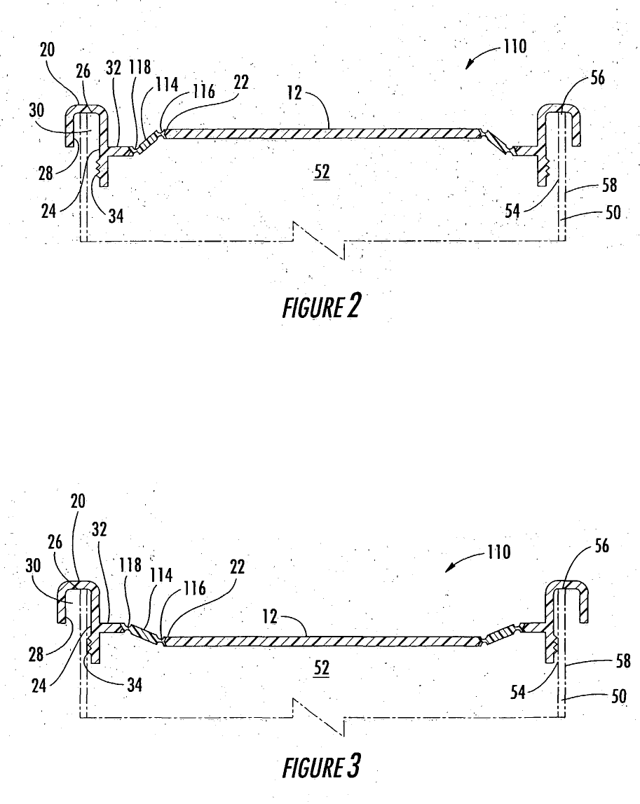

FIG. 1 illustrates a flex panel lid 10 of the present invention. The lid 10 has a center panel 12 surrounded by a hinge portion 14 and a rim portion 20. The hinge portion 14 includes a first flex point 16 and a second flex point 18 spaced radially outward thereof. The hinge portion 14 allows the center panel 12 to be moved axially relative to the rim portion 20. Axial movement of the center panel 12 moves the rim portion 20 radially. When lid 110 is placed on a container 50, as shown in FIG. 2, axial movement of the center panel 12 moves the rim portion 20 from the unsealing position of FIG. 2 to the sealing position of FIG. 3 to create a seal for storage of the products stored within the container.

The lid 10 as shown in FIG. 1 is a circular lid; however, other embodiments of the invention may include shapes such as square, rectangular, and oval, to list a few non-limiting examples. The terms radial and radially are used to describe the illustrated embodiment of the lid 10; however, other embodiments having non-circular shapes are also described wherein the radial direction corresponds to a direction generally outward from a center of the lid. The rim portion 20 includes a groove 30 defined by the radial distance between an inner wall 24 and outer wall 28. A top flange 26 connects inner wall 24 to outer wall 28, as shown in FIG. 2. The groove 30 is structured and arranged to receive the edge 56 of container 50 defining the opening 52 of the container to be sealed. As shown in FIG. 2, the edge 56 comprises an inner surface 54 and an outer surface 58 and includes no additional features to facilitate attachment and sealing of the lid 10. However, other embodiments of the invention may comprise a lid 110 with a groove 30 adapted to cooperate with additional features on edge 56, such as a bead or the like.

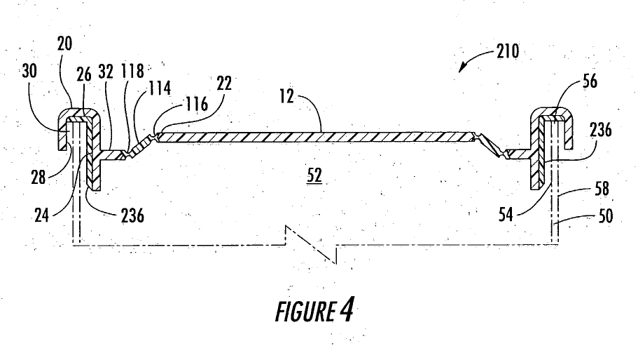

FIG. 2 illustrates the lid 110 in the unsealing position, while FIG. 3 shows the lid in the sealing position. Axial movement of the center panel 12 moves the rim portion 20 radially. The lid 110 of the present invention shown in FIG. 2 and FIG. 3, as well as lid 210 in FIG. 4 and lid 310 in FIG. 4 and FIG. 5, is structured such that axial movement of the center panel 12 in the direction toward the container 50 moves the rim portion 20 radially outward. Alternatively, the lid can be arranged such that movement of, the center panel 12 axially away from the container 50 causes the rim portion 20 to move radially outward.

The center panel 12 of the illustrated embodiment consists of a flat circular disc. The center panel 12 is preferably located in the center of lid 110 and includes an outer perimeter 22. As shown in FIG. 2, the center panel 12 is a flat disc with no surface features or variations in thickness; however, other embodiments of the invention may include surface textures, portions of differing thicknesses, or ornamental designs, to list some non-limiting examples. The center panel 12 also is not required to be flat but may include either convex or concave curvature. Furthermore, a pull feature 448, as seen in FIG. 8, is included in other embodiments of a lid 410 to facilitate axial movement of the, center panel 12. The pull feature 448 shown in FIG. 8 is a simple flexible hoop, though a pull feature of any configuration may be incorporated into the top surface of the center panel 12, such as a flat flange perpendicular to the center panel, a flexible flap projecting upwards, or a mushroom-type feature, to list some non-limiting examples.

The hinge portion 114 surrounds the center panel 12 and is attached to the outer perimeter 22 of the center panel 12, as shown in FIG. 2. The hinge portion 114 is also attached to an inwardly projecting flange 32 of the rim portion 20. The hinge portion 114 illustrated in FIG. 2 and FIG. 3 includes two flex points 116 and 118. However, other embodiments of the invention may include any number of flex points. The first flex point 116 and the second flex point 118 are connected by a web that generally is of the same thickness as the center panel 12; however, the web may have a dissimilar thickness in other embodiments. The flex points 116 and 118 are each defined by a channel on the top surface of the lid 110 and a channel on the bottom surface of the lid at corresponding distances from the center of the lid. Therefore, the flex point 116 is defined by a top channel and a bottom channel and the flex point 118 is defined by a top channel and a bottom channel such that the thickness of the hinge portion 114 at the flex points is less than the thickness of the web connecting the flex points and less than the thickness of the adjacent center panel 12 or the adjacent inwardly projecting flange 32 of rim portion 20. The embodiment of lid 10 shown in FIG. 1 does not include the channels at the flex points 16 and 18, such that the thickness of the flex points is approximately equal to the thickness of the web, yet the lid 10 functions in a similar fashion as the lid 410 of FIG. 2. Indeed, the ability of the lid to flex and pivot about a particular point can be provided by tailoring the thickness distribution of the lid and the radii of curvature of the lid surfaces in those regions where the; thickness is changing rapidly in the radial direction; thus, the hinge points do not have to be as sharply defined as those depicted in FIG. 2.

The four channels correlating to the two flex points 116 and 118 are configured to predispose the lid 110 to either the unsealing position of FIG. 2 or the sealing position of FIG. 3. An example of the flex points 116 and 118 predisposing the lid 110 to either the unsealing or sealing position would be where if the center panel 12 is above the plane defined by the inwardly projecting flange 32 of the rim portion 20, the center panel would tend to move up to the unsealing position, but if the center panel is aligned with or below the plane defined by the inwardly projecting flange of the rim portion, the center panel would tend to move down to the sealing position. The memory of the hinge portion 114 material provides the inducement for predisposing the lid 110.

The channels defining the flex points are preferably structured such that when the center panel 12 is moved axially the rim portion 20 moves a corresponding distance in a radial direction. The correlation between the axial distance moved and the radial distance moved is governed by the angle of the hinge portion in the unsealing position compared to the angle of the hinge portion in the sealing position. The size, shape, and location of the channels defining the flex points 116 and 118 also define the angles of the hinge portion 114, as well as the location of the center panel 12 and the rim portion 20, in the unsealing and sealing positions. As seen in FIG. 2 and FIG. 3, the angle of the hinge portion 114 relative to the center panel 12, which is generally equal to the angle of the hinge portion relative to the inwardly projecting flange 32 of the rim portion 20, in the unsealing position of FIG. 2 is greater than the angle in the sealing position of FIG. 3. This difference in angle correlates to the different radial locations of the rim portion 20 in the unsealing and sealing positions. Therefore, increasing the difference in angles of the unsealing and sealing positions increases the difference in radial locations of the rim position such that optimal sealing my be provided for a specific container. Furthermore, the shape of the hinge portion 114 and the material used to form the hinge portion govern the amount of force required to move the center panel 12 axially and the rim portion 20 radially. The force required to convert the lid 110 to the sealing position is also governed by the outside diameter of the inner wall 24 of the rim portion 20 compared to the inside diameter of the container opening 52.

The rim portion 20 surrounds the center panel 12 and the hinge portion 114. The rim portion 20 includes an inwardly projecting flange 32 projecting from an inside surface of the inner wall 24 toward the center of the lid 110. The outer extremity of the hinge portion 114 is connected to an inner extremity of the inwardly projecting flange 32. The inwardly projecting flange 32 shown in FIG. 2 is located axially between the lower portion of the inner wall 24 and the upper portion of the inner wall. However, in other embodiments of the invention, the inwardly projecting flange 32 may be located at any axial point along the inner wall 24. A top flange 26 is attached to the upper portion of the inner wall 24 and extends radially outward to the outer wall 28. As shown in FIG. 2, the outer wall 28 extends downwardly from the top flange 26, but in other embodiments may include an upwardly extending portion.

The inner wall 24 of FIG. 2 includes a container-engaging feature 34 comprising multiple peripheral ridges on the outside surface of the inner wall. As shown in FIG. 3, the container-engaging feature 34 engages the inner surface 54 of the container 50. The container-engaging feature 34 preferably enhances the sealing ability of the inner wall 24.

An alternative container-engaging surface 236, as illustrated in the embodiment of FIG. 4, may also be incorporated for enhanced sealing of lid 210 to container 50. The container-engaging surface 236, is formed with a pliable material that is more compliant than the material comprising the other portions of the rim portion 20 to improve the sealing ability of the lid 210. The surface 236, for example, can more-readily conform to irregularities in the shape or surface of the container edge. Additionally, the material making up the surface 236 can be higher-friction material and thereby better resist detachment of the lid 210 from the container 50.

In operation, the lid 110 in FIG. 2 and FIG. 3 is placed over the opening 52 of container 50 so that the groove 30 of rim portion 20 receives the edge 56 of the container. Clearance is provided between the container-engaging feature 34 of the inner wall 24 of rim portion 20 and the inner surface 54 of the container, but other embodiments may provide nominal engagement of the container-engaging feature 34 with the inner surface 54 such that resistance to placement of the lid 110 onto container 50 is minimal. Other embodiments may include a container-engaging surface 236, as in FIG. 4. Once the top of edge 56 engages the bottom surface of the top flange 26, the lid 110 may be converted from the unsealing position of FIG. 2 to the sealing position of FIG. 3. Applying force in a direction toward the container 50 to the center panel 12 moves the center panel toward the container and the rim portion 20 outwardly. The container-engaging feature 34 engages the inner surface 54 of the container 50 while the lid 110 is being converted from the unsealing position to the sealing position. The container-engaging feature 34 maintains engagement with the inner surface 54 of the container 50 once the lid 110 is in the sealing position, and the hinge portion 114 keeps the lid in the sealing position.

While the lid 110 is in the sealing position, the contents of the container 50 are protected from contaminants of the surrounding environment and are prevented from leaking out of the container.

To remove the lid 110 in the sealing position from the container 50, as shown in FIG. 3, the center panel 12 preferably is first moved axially away from the container to convert the lid to the unsealing position. A pull feature 448, as shown in FIG. 8, is preferably provided to facilitate the axial movement of the center panel 12 away from the container. Once the center panel 12 is pulled to the unsealing position, the container-engaging feature 34 of the inner wall 24 of the rim portion 20 is moved inwardly such that the container-engaging feature no longer engages or nominally engages the inner surface 54 of the container 50 so that the lid 110 may be removed with minimal resistance. Alternatively, it may be possible to pry the lid 110 off the container 50 without first converting the lid to the unsealing position, although a greater amount of force may be required to do so.

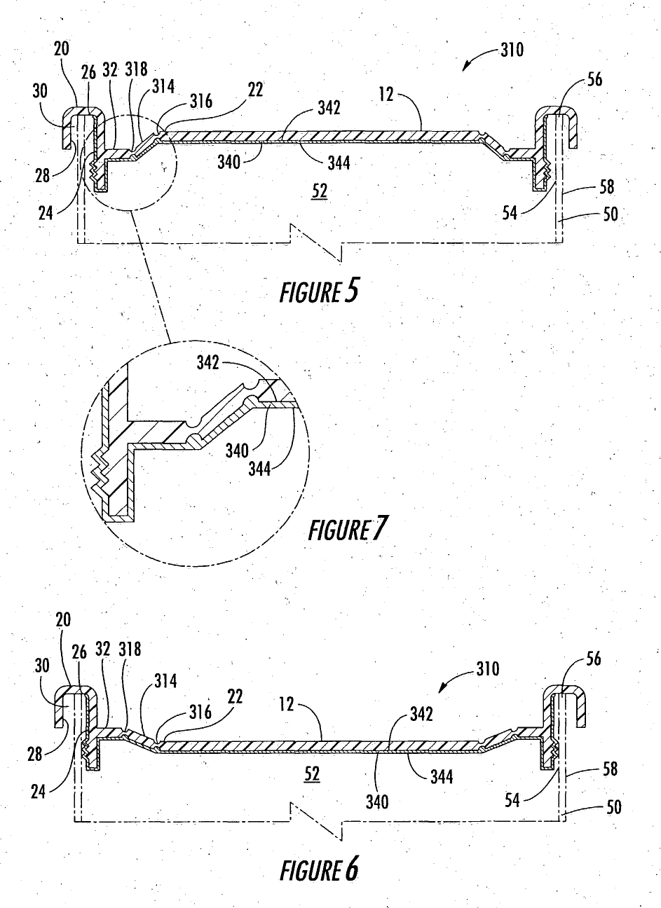

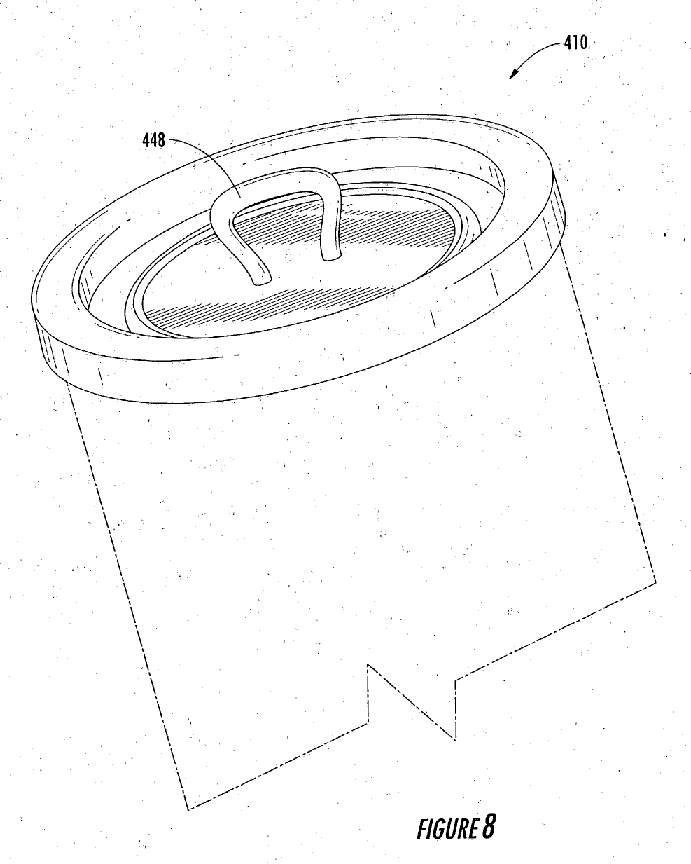

At least one motivation for sealing a container 50 is to prevent exposure of the contained product to moisture and oxygen. Spoilage of many products, in particular food products, is accelerated when the product is exposed to moisture or oxygen. Therefore, transmission of moisture and oxygen through a lid should be minimized or prevented not only before the container is first opened by a consumer, but also while the container is subsequently resealed. Accordingly, the lid of the present invention preferably includes barrier materials to reduce moisture and oxygen transmission rates. Various types of barrier materials can be used. In one advantageous embodiment, the cap 310 of FIG. 5 and FIG. 6 is a molded cap that integrates a flexible barrier membrane 340. A flexible barrier membrane 340 improves the barrier properties of the cap 310 so as to prevent the passage of moisture and/or oxygen. One embodiment of cap 310 includes a flexible barrier membrane 340 that is a metallized film, or more particularly, is a metal foil. Other embodiments include any type of flexible barrier membranes. The flexible barrier membrane 340 of FIG. 5, includes an upper polymer layer 342 and a lower foil layer 344 such that the cap 310 is molded onto the upper polymer layer 342 and the lower foil layer defines a bottom surface or container-facing surface of the cap. The upper polymer layer 342 of the flexible barrier membrane includes materials to enhance the bond between the cap material and the flexible barrier membrane 340. The flexible barrier membrane 340 of FIG. 7 extends radially from the center of the cap 310 to the groove 30 of the rim portion 20. The flexible barrier membrane 340 preferably spans the entire opening 52 of the container 50, as shown in FIG. 6, to provide the maximum seal for the container. However, other embodiments of the cap 310 may integrate a flexible barrier membrane 340 that does not extend to the groove 30 of the rim portion 20. Furthermore, other embodiments of the cap 310 may include a flexible barrier membrane 340 that defines a top surface of the cap or is encased within the cap.

The lid 110 illustrated in FIG. 2 is manufactured by a two shot mold process such that the center panel 12 and the rim portion 20 consists of a first mold material and the hinge portion 114 consists of a second mold material. The first mold material is different from the second mold material, and in one embodiment of the invention is relatively less-compliant than the second mold material. A further embodiment of the invention includes a first mold material that is a thermoplastic and a second mold material that is an elastomer. Non-limiting examples of materials that may be used as the first mold material include various polyolefins (including homopolymers, co-polymers, etc.), polyester, and others. Nonlimiting examples of second mold materials include various elastomeric materials such as thermoplastic rubber, thermoplastic elastomer; or any other suitable material. Utilizing a relatively less-compliant material for the center panel 12 and rim portion 20 provides structural strength to the lid 110. Furthermore, the relatively more-compliant material of the hinge portion 114 requires less force to move the center panel axially and enables the hinge portion to undergo additional cycles of actuation between the unsealing and sealing positions without damaging the material of the relatively thin flex points 116 and 118.

A method of manufacturing the lid 110 of FIG. 2 and FIG. 3 requires a mold that includes a cavity shaped as a lid in either the unsealing or sealing position. A first mold material is injected into the mold such that the center panel 12 and the rim portion 20 are formed. The outer perimeter 22 of the center panel 12 and the inwardly projecting flange 32 of then rim portion 20 are separated by an axial and radial distance. The second mold material is injected into the portion of the mold separating the outer perimeter 22 of the center panel 12 and the inwardly projecting flange 32 to form the hinge portion 114 that connects the outer perimeter to an inside edge of the inwardly projecting flange. The second mold material may be injected prior to, simultaneous with, or subsequent to the injection of the first mold material, but must be completed in a timely fashion to maximize the bond strength at the interface between the hinge portion 114 and the outer perimeter 22 of the center panel 12 and between the hinge portion 114 and the inwardly projecting flange 32. After the first mold material and the second mold material have been fully injected into the mold, the materials are sufficiently hardened so that the lid 110 will retain the configuration provided by the mold after the lid has been removed from the mold. Various hardening techniques may be used, such as with air cooling or by UV exposure, to list two non-limiting examples; however, optimal hardening techniques for the specific mold materials are preferably used.,

Manufacture of the lid 210 of FIG. 4 includes an additional injection of mold material into the groove 30 of the rim portion 20 to form a container-engaging surface 236. The container-engaging surface 236 consists of a pliable material that is more compliant than other portions of the rim portion so as to promote sealing of the lid 10 to the inner surface 54 of the container 50. The container-engaging surface 236 of FIG. 4 is positioned on the outside surface of the inner wall 24 and on the bottom surface of the top flange 26. Other embodiments of the lid 210 may include a container-engaging surface 236 positioned only on the outside surface of the inner wall 24 or consisting of a strip of pliable material with an axial height less than the axial height of the outside surface of the inner wall 24. The pliable material of container-engaging surface 236 provides more surface area for contacting the inner surface 54 of the container 50 than the container-engaging feature 34 of FIG. 2 and enhances the sealing ability of the lid by reducing the possibility of gaps in the sealing engagement. As illustrated in FIG. 4, the container-engaging surface 236 consists of the same second mold material of hinge portion 114, and during manufacture is injected concurrently with the injection creating the hinge portion. Other embodiments of the invention may include a container-engaging surface 236 of a mold material different than the rim portion 20 and the hinge portion 114.

The cap 310 of FIGS. 5, 6, and 7 is manufactured by a method similar to the embodiment of FIG. 2, but integrates the flexible barrier membrane 340. Before injection of one or multiple mold materials into the mold, the flexible barrier membrane is positioned in the mold in a location corresponding to the position of the flexible barrier membrane in the finished cap 310. For the cap 310 of FIG. 5, the flexible barrier membrane 340 is placed on the bottom surface of the mold pattern with the lower foil layer 344 facing downward on the mold such that injection of the mold material will occur above the flexible barrier membrane only. This positioning allows the upper polymer layer 342 to contact the injected mold material to create the bond between the flexible barrier membrane 340 and the mold material of cap 310. Other embodiments of the cap 310 may include an upper layer 342 that includes adhesives, such as heat-sensitive adhesives to name a non-limiting example, or other materials to facilitate bonding between the flexible barrier membrane 340 and the mold material. As seen in FIG. 5, the flexible barrier membrane 340 extends radially to the groove 30 of the rim portion 20. In so doing, the flexible barrier membrane 340 must match the contours of the hinge portion 314 and the inner wall 24, as shown in FIG. 7. To insure the flexible barrier membrane 340 is properly located and the flexible barrier membrane includes the intended configuration, the flexible barrier membrane of some embodiments of the invention requires force during the positioning step so that the flexible barrier membrane is shaped to match the contours of the mold and hence the resulting features of the cap 310. Other embodiments may require only positioning of the flexible barrier membrane 340 into the mold, wherein the injection of the mold material sufficiently shapes the flexible barrier membrane by the force or pressure of the injection step.

The cap 310 of FIG. 5 and FIG. 6 is manufactured with one mold material comprising the center panel 12, the hinge portion 314, and the rim portion 20; therefore, a single injection of a first mold material onto the flexible barrier membrane 340 for the cap 310. Other embodiments of the invention include a cap 310 manufactured by a two shot mold process, similar to the lid 110 of FIG. 2 and FIG. 3, wherein the center panel 12 and rim portion 20 consist of a first mold material that is relatively less-compliant than the second mold material of the hinge portion 314. Further embodiments include a cap 310 with a flexible barrier membrane 340 and a container-engaging surface similar to the container-engaging surface 236 of FIG. 4. The flexible barrier membrane 340 of such an embodiment preferably extends radially to the groove 30 but does not contact the container-engaging surface 236, thus providing improved barrier properties while creating an improved seal. Further embodiments of cap 310 may include any combinations of the features described herein.

The pull feature 448, as represented in FIG. 8, is preferably incorporated into the lid 410 during the mold process. The mold used to manufacture the lid 410 includes a cavity corresponding to the pull feature 448 such that when a mold material is injected into the mold to form the center panel 12, mold material also enters the cavity defining the pull feature. In such a way, the pull feature 448 is integrated into the lid 410 during the mold process, and the lid 410 is a finished product after hardening. However, other embodiments of the invention may include a pull feature 448 that is added to a lid 410, subsequent to the hardening step, such as with a fastener or adhesive, to provide two non-limiting examples.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A lid for a container, comprising:
a center panel having an outer perimeter;
a rim portion encircling the center panel, the rim portion defining a groove for receiving an upper edge of the container so as to secure the, lid to the upper edge, the groove being defined between radially spaced inner and outer walls; and
a hinge portion connecting the rim portion to the outer perimeter of the center panel, the hinge portion allowing the center panel to be moved axially relative to the rim portion between an unsealing position and a sealing position, the center panel in the sealing position causing the rim portion to be moved radially outwardly to urge the inner wall of the groove against an inner surface of the container adjacent the upper edge thereof;
wherein at least portions of the center panel and rim portion comprise a relatively less-compliant polymer material and the hinge portion comprises a relatively more-compliant polymer material.

2. A lid according to claim 1, wherein the relatively less-compliant polymer material is a thermoplastic material.

3. A lid according to claim 2, wherein the relatively more-compliant polymer material is an elastomer.

4. A lid according to claim 1, wherein a container-engaging surface of the rim portion is formed of a pliable material that is more compliant than other portions of the rim portion so as to promote sealing with the inner surface of the container.

5. A lid according to claim 4, wherein the pliable material of the container-engaging surface is an elastomer.

6. A lid according to claim 1, wherein axial movement of the center panel toward the container converts the lid into the sealing position and axial movement of the center panel away from the container converts the lid into the unsealing position.

7. A lid according to claim 1, wherein axial movement of the center panel away from the container converts the lid into the sealing position and axial movement of the center panel toward the container converts the lid into the unsealing position.

8. A lid according to claim 1, wherein the center panel includes a pull feature to facilitate axial movement of the center panel.

9. A lid according to claim 1, wherein the hinge portion includes two flex points.

10. A lid according to claim 1, wherein the inner wall and the outer wall are both generally axially oriented.

11. A lid according to claim 10, wherein the inner wall and the outer wall are both substantially perpendicular to the center panel in the sealing position and in the unsealing position.

12. A molded cap for a container, comprising:
a center panel having an outer perimeter;
a rim portion encircling the center panel, the rim portion defining a groove for receiving an upper edge of the container so as to secure the cap to the upper edge, the groove being defined between radially spaced inner and outer walls;
a hinge portion connecting the rim portion to the outer perimeter of the center panel, the hinge portion allowing the center panel to be moved axially relative to the rim portion between an unsealing position and a sealing position, the center panel in the sealing position causing the rim portion to be moved radially outwardly to urge the inner wall of the groove against an inner surface of the container adjacent the upper edge thereof; and
a flexible barrier membrane integrated into the cap to improve the barrier properties of the cap.

13. A molded cap according to claim 12, wherein the flexible barrier membrane includes a lower foil layer and an upper polymer layer for joinder with the mold material.

14. A molded cap according to claim 13, wherein the cap, is molded onto the upper polymer layer of the flexible barrier membrane such that the lower foil layer of the flexible barrier membrane defines a container-facing surface of the cap.

15. A molded cap according to claim 13, wherein the flexible barrier membrane extends radially to the groove of the rim portion.

16. A molded cap according to claim 12, wherein the flexible barrier membrane is a metallized film.

17. A molded cap according to claim 16, wherein the metallized film is a metal foil.

18. A molded cap according to claim 12, wherein the cap is formed by a two shot mold process such that the center panel and the rim portion comprise a relatively less-compliant polymer material and the hinge portion comprises a relatively more-compliant material.

19. A molded cap according to claim 12, wherein a container-engaging surface of the rim portion is formed of a pliable material that is more compliant than other portions of the rim portion so as to promote sealing with the inner surface of the container.

20. A molded cap according to claim 12, wherein axial movement of the center panel toward the container converts the lid into the sealing position and axial movement of the center panel away from the container converts the lid into the unsealing position.

21. A molded cap according to claim 12, wherein axial movement of the center panel away from the container converts the lid into the sealing position and axial movement of the center panel toward the container converts the lid into the unsealing position.

22. A molded cap according to claim 12, wherein the center panel includes a pull feature to facilitate axial movement of the center panel.

23. A molded cap according to claim 12, wherein the hinge portion includes two flex points.

24. A molded cap according to claim 12, wherein the inner wall and the outer wall are both generally axially oriented and are both substantially perpendicular to the center panel in the sealing position and in the unsealing position.

25. A method of manufacturing a lid for a container, comprising the steps of:
injecting a first mold material into a mold to form a center panel having an, outer perimeter and to form a rim portion encircling the center panel;
injecting a second mold material different from the first mold material into the mold to form a hinge portion connecting the rim portion to the outer perimeter of the center panel; and
hardening the first mold material and the second mold material;
wherein after hardening of the lid, the hinge portion allows the center panel to be moved axially relative to the rim portion.

26. A method according to claim 25, wherein the first mold material is a relatively less compliant material than the second mold material.

27. A method according to claim 26, wherein the injecting a first mold material step comprises injecting a thermoplastic material and injecting a second mold material step comprises injecting an elastomer.

28. A method according to claim 27, wherein the rim portion is formed to have a groove for receiving an upper edge of the container, and wherein the injecting a second mold material step forms a container-engaging surface of the groove.

29. A method according to claim 25, wherein the center panel is formed to have a pull feature.

30. A method according to claim 25, wherein the hinge portion is formed to have two flex points.

31. A method of manufacturing a molded cap for a container, comprising the steps of:
positioning a flexible barrier membrane in a mold;
injecting a mold material into the mold to form a center panel having an outer perimeter, a rim portion encircling the center panel, and a hinge portion correcting the rim portion to the outer perimeter of the center panel; and
hardening the mold material to form the cap so that the flexible barrier membrane is integrated into the cap;
wherein after hardening of the lid, the hinge portion allows the center panel to be moved axially relative to the rim portion.

32. A method according to claim 31, wherein the flexible barrier membrane includes a lower foil layer and an upper polymer layer for joinder with the mold material.

33. A method according to claim 32, wherein the injecting step is an injection of the mold material onto the upper polymer layer of the flexible barrier membrane such that the lower foil layer of the flexible barrier membrane defines a container-facing surface of the cap.

34. A method according to claim 31, wherein the injecting step is an injection of the mold material onto a top surface of the flexible barrier membrane such that the flexible barrier membrane extends radially to a container-engaging surface of the rim portion.

35. A method according to claim 31, wherein the positioning step includes a flexible barrier membrane that is a metallized film.

36. A method according to claim 31, wherein the center panel is formed to have a pull feature.

37. A method according to claim 31, wherein the hinge portion is formed to have two flex points.
